(19) United States
(12) Patent Application Publication
(10) Pub. No.: US 2026/0177747 A1
(43) Pub. Date: Jun. 25, 2026

(54) DEPOLARIZATION INTEGRATED OPTICAL CHIP MODULE AND MANUFACTURING METHOD THEREOF

(71) Applicant: CORETECH OPTICAL CO., LTD., Hsinchu County (TW)

(72) Inventor: CHIN-CHIEN CHEN, Hsinchu County (TW)

(21) Appl. No.: 19/419,190

(22) Filed: Dec. 15, 2025

(30) Foreign Application Priority Data
Dec. 20, 2024 (TW) 113214074

(51) Int. Cl. G02B 6/126; G02B 6/024; G02B 6/12; G02B 6/125; G02B 6/13

(52) U.S. Cl. CPC G02B 6/126; G02B 6/024; G02B 6/125; G02B 6/13; G02B 2006/121; G02B 2006/12111; G02B 2006/1215

(57) ABSTRACT

The disclosure provides a depolarization integrated optical chip module, which includes a chip body, a light guiding structure, and an optical fiber circuit. The chip body has a first end and a second end. The light guiding structure includes an input connection portion, a first output connection portion, and a second output connection portion. The input connection portion is disposed at the first end, and the first output connection portion and the second output connection portion are disposed at the second end. The optical fiber circuit includes a first waveguide optical path, a second waveguide optical path, a third waveguide optical path, an input optical path, a first output optical path, and a second output optical path connected to each other. The disclosure further provides a manufacturing method of the module.

### CROSS REFERENCE TO RELATED APPLICATION

All related applications are incorporated by reference. The present application is based on, and claims priority from, Taiwan Application Serial Number 113214074, filed on Dec. 20, 2024, the disclosure of which is hereby incorporated by reference herein in its entirety.

### TECHNICAL FIELD

The disclosure relates to a multi-functional integrated optics chip (MIOC), in particular to a depolarization multi-functional integrated optical chip module. The disclosure further relates to the manufacturing method of the depolarization multi-functional integrated optical chip module.

### BACKGROUND

Integrated optics, also referred to as photonic integrated circuits (PIC), has become one of the technologies that attract the most attention in recent years. Unlike integrated circuits, integrated optics utilizes light as the medium for signal transmission, allowing optical signals to be processed within a chip. Integrated optics can achieve many advantages, such as high speed and low power consumption. The multi-functional integrated optics chip is a key component for a fiber optical gyroscope. It's a waveguide device on single polarization LiNbO₃ substrate fabricated by proton exchange method. It has a Y-junction coupler and a push-pull electrode on surface which is an electro-optic phase modulator.

In technologies employing integrated optical chips, polarization maintaining fiber is often used as the optical transmission line. However, currently available polarization maintaining fibers still suffers from relatively high cost. In particular, when applied to fiber gyroscope devices, a substantial length of fiber coil is required, which significantly increases the overall product cost.

### SUMMARY

One embodiment of the disclosure provides a depolarization integrated optical chip module, which includes a chip body, a light guiding structure and an optical fiber circuit. The chip body has a first end and a second end opposite to the first end. The light guiding structure includes an input connection portion, a first output connection portion, and a second output connection portion. The input connection portion is disposed at the first end. The first output connection portion and the second output connection portion are disposed at the second end. The optical fiber circuit includes a first waveguide optical path, a second waveguide optical path, a third waveguide optical path, an input optical path, a first output optical path, and a second output optical path. The first waveguide optical path, the second waveguide optical path, and the third waveguide optical path are connected with each other and disposed in the chip body. The input optical path, the first output optical path, and the second output optical path are respectively disposed on the input connection portion, the first output connection portion, and the second output connection portion, and are respectively connected to the first waveguide optical path, the second waveguide optical path, and the third waveguide optical path. Each of the input optical path, the first output optical path, and the second output optical path includes a fiber core, a first stress applying rod, and a second stress applying rod. The first applying rod and the second applying rod are disposed on an outer periphery of the fiber core and arranged annularly at equal intervals. The first applying rod and the second applying rod of each of the first output optical path and the second output optical path are inclined relative to a horizontal plane by 45 degrees (45°) with respect to the fiber core serving as the center.

Another embodiment of the disclosure provides a method of manufacturing a depolarization integrated optical chip module, which includes the following steps: disposing a first waveguide optical path, a second waveguide optical path, and a third waveguide optical path in a chip body, where the first waveguide optical path, the second waveguide optical path, and the third waveguide optical path are connected to each other; disposing an input optical path on an input connection portion; respectively disposing a first output optical path and a second output optical path on a first output connection portion and a second output connection portion; aligning the input optical path with the first waveguide optical path, and respectively aligning the first output optical path and the second output optical path with the second waveguide optical path and the third waveguide optical path; adjusting the first output connection portion through an adjustment platform to make the first applying rod and the second applying rod of the first output optical path be inclined relative to a horizontal plane by 45° with respect to the fiber core of the first output optical path serving as the center; and adjusting the second output connection portion through the adjustment platform to make the first applying rod and the second applying rod of the second output optical path be inclined relative to the horizontal plane by 45° with respect to the fiber core of the second output optical path serving as the center.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The disclosure will become more fully understood from the detailed description given herein below and the accompanying drawings which are given by way of illustration only, and thus are not limitative of the disclosure and wherein:

FIG. 1 is a schematic view of a depolarization integrated optical chip module in accordance with a first embodiment of the disclosure.

FIG. 2 is a schematic view for illustrating the depolarization integrated optical chip module disposed in a fiber optic gyroscope in accordance with the first embodiment of the disclosure.

FIG. 3A is a first schematic view of an input optical path of the depolarization integrated optical chip module in accordance with the first embodiment of the disclosure.

FIG. 3B is a second schematic view of the input optical path of the depolarization integrated optical chip module in accordance with the first embodiment of the disclosure.

FIG. 4A is a first schematic view of an output optical path of the depolarization integrated optical chip module in accordance with the first embodiment of the disclosure.

FIG. 4B is a second schematic view of the output optical path of the depolarization integrated optical chip module in accordance with the first embodiment of the disclosure.

FIG. 5 is an exploded view of a depolarization integrated optical chip module in accordance with a second embodiment of the disclosure.

FIG. 6 is a perspective view of the depolarization integrated optical chip module in accordance with the second embodiment of the disclosure.

FIG. 7 is a schematic view of an input optical path of the depolarization integrated optical chip module in accordance with the second embodiment of the disclosure.

FIG. 8A is a first schematic view of an output optical path of the depolarization integrated optical chip module in accordance with the second embodiment of the disclosure.

FIG. 8B is a second schematic view of the output optical path of the depolarization integrated optical chip module in accordance with the second embodiment of the disclosure.

FIG. 9 is a top view of the depolarization integrated optical chip module in accordance with the second embodiment of the disclosure.

FIG. 10 is a flow chart of a method of manufacturing a depolarization integrated optical chip module in accordance with a third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

The directional terms used herein, such as upper, lower, left, right, front, rear and their derivatives or synonyms, refer to the orientations of the elements shown in the drawings and are not intended to limit the disclosure, unless otherwise expressly stated in the context.

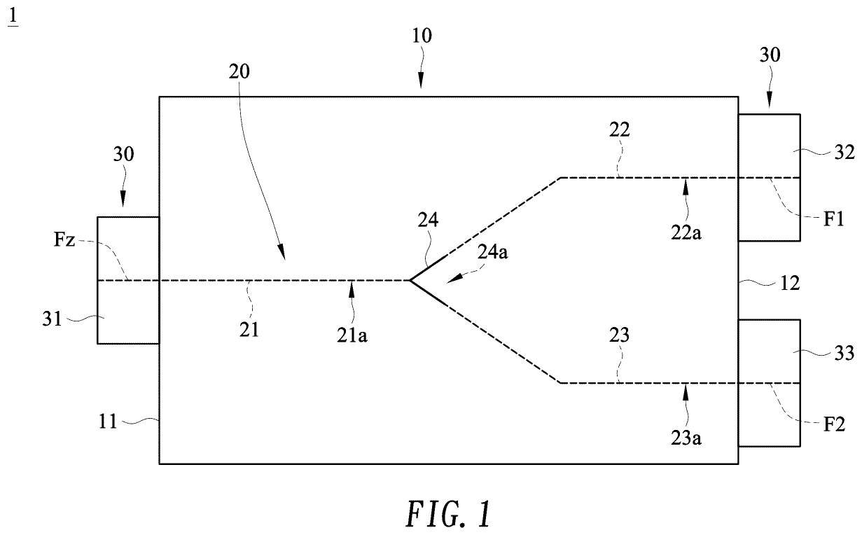

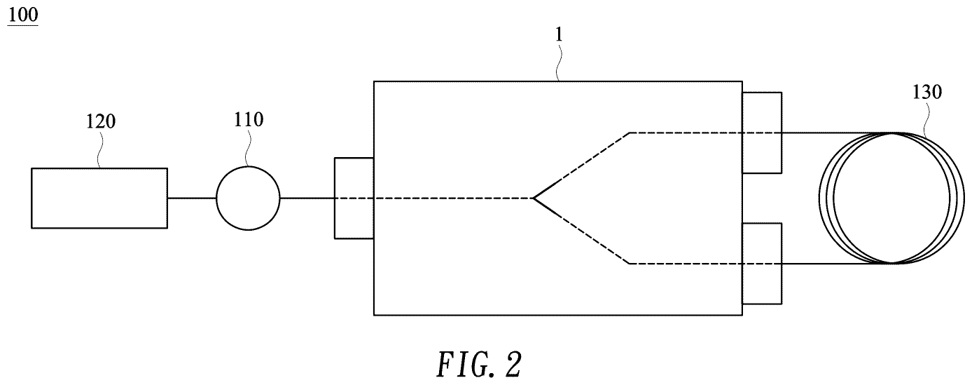

Please refer to FIG. 1 and FIG. 2. FIG. 1 is a schematic view of a depolarization integrated optical chip module in accordance with a first embodiment of the disclosure. FIG. 2 is a schematic view for illustrating the depolarization integrated optical chip module disposed in a fiber optic gyroscope in accordance with the first embodiment of the disclosure. As shown in FIG. 1 and FIG. 2, the embodiment provides a depolarization integrated optical chip module 1, particularly applied to an integrated optical chip in a fiber optic gyroscope device 100. The light guiding structure of the waveguide optical path is shown in FIG. 1. FIG. 1 illustrates a depolarization integrated optical chip module 1 disposed in a fiber optic gyroscope 100 (shown in FIG. 2). The depolarization integrated optical chip module 1 includes a chip body 10, an optical fiber circuit 20, and a light guiding structure 30. In this embodiment, for simplifying the description of the configuration of the depolarization integrated optical chip module 1 and for ease of illustration, the optical fiber circuit 20 is represented only by dashed lines in FIG. 1 to indicate its corresponding connection relationship.

The chip body 10 has a first end 11 and a second end 12. The first end 11 and the second end 12 are respectively disposed on opposite sides of the chip body 10. The light guiding structure 30 is disposed at the first end 11 and the second end 12.

The optical fiber circuit 20 includes a first waveguide optical path 21, a second waveguide optical path 22, a third waveguide optical path 23, a light splitting unit 24, an input optical path Fz, a first output optical path F1, and a second output optical path F2. The first waveguide optical path 21, the second waveguide optical path 22, and the third waveguide optical path 23 are connected to each other through the light splitting unit 24, and are disposed in the chip body 10. The first waveguide optical path 21, the second waveguide optical path 22, the third waveguide optical path 23 and the light splitting unit 24 form a Y waveguide structure. The first waveguide optical path 21 receives an input optical signal from the first end 11 and transmits the input optical signal toward the second end 12. The light splitting unit 24 is connected to the downstream 21a of the first waveguide optical path 21 and receives the input optical signal transmitted from the first waveguide optical path 21. The light splitting unit 24 splits the input optical signal into multiple output optical signals. The second waveguide optical path 22 and the third waveguide optical path 23 are connected to the downstream 24a of the light splitting unit 24 and are separated from each other so as to respectively receive the output optical signals. The downstream 22a and 23a of the second waveguide optical path 22 and the third waveguide optical path 23 output the optical signals from the second end 12 of the chip body 10. In this embodiment, the optical fiber circuit 20 illustrates dividing the first waveguide optical path 21 into two paths (the second waveguide optical path 22 and the third waveguide optical path 23) as an example instead of a limitation.

The light guiding structure 30 includes an input connection portion 31, a first output connection portion 32, and a second output connection portion 33. The input optical path Fz, the first output optical path F1, and the second output optical path F2 are respectively disposed on the input connection portion 31, the first output connection portion 32, and the second output connection portion 33, and are respectively connected to the first waveguide optical path 21, the second waveguide optical path 22, and the third waveguide optical path 23. The input connection portion 31 is disposed at the first end 11 of the chip body 10 so that the input optical path Fz is connected to the first waveguide optical path 21. The first output connection portion 32 is disposed at the second end 12 of the chip body 10, such that the first output optical path F1 is connected to the second waveguide optical path 22. The second output connection portion 33 is disposed at the second end 12 of the chip body 10, such that the second output optical path F2 is connected to the third waveguide optical path 23. The input optical signal is input from the input optical path Fz on the input connection portion 31 into the first waveguide optical path 21. The output optical signals output from the second waveguide optical path 22 and the third waveguide optical path 23 are output via the first output optical path F1 on the first output connection portion 32 and the second output optical path F2 on the second output connection portion 33. In this embodiment, the input optical path Fz, the first output optical path F1, and the second output optical path F2 are polarization maintaining fibers.

The embodiment just exemplifies the disclosure and is not intended to limit the scope of the disclosure. Any equivalent modification and variation according to the spirit of the disclosure is to be also included within the scope of the following claims and their equivalents.

As shown in FIG. 2, the input optical path Fz on the input connection portion 31 may be regarded as the input end. The first output optical path F1 on the first output connection portion 32 and the second output optical path F2 on the second output connection portion 33 may be regarded as the output ends. The input end may be connected to the optical circulator 110 and/or the laser light source 120 of the fiber optic gyroscope 100 to receive optical signals. The output ends may be connected to the optical fiber coil 130 of the fiber optic gyroscope 100 to output optical signals.

The embodiment just exemplifies the disclosure and is not intended to limit the scope of the disclosure. Any equivalent modification and variation according to the spirit of the disclosure is to be also included within the scope of the following claims and their equivalents.

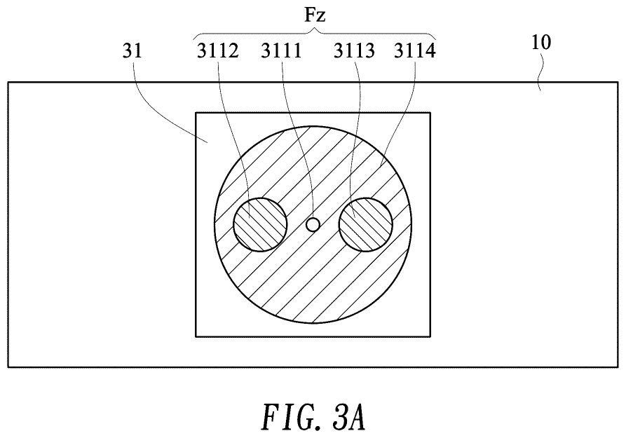

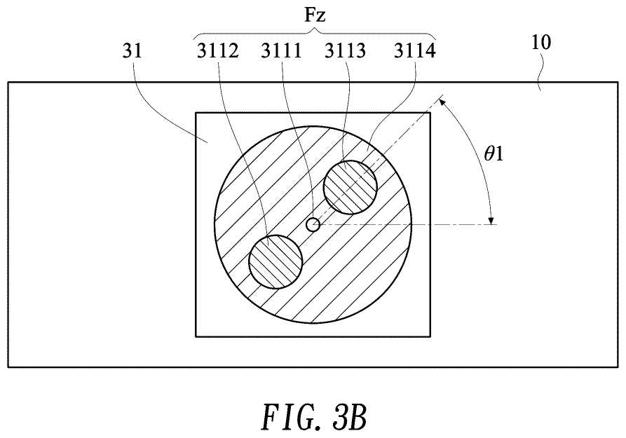

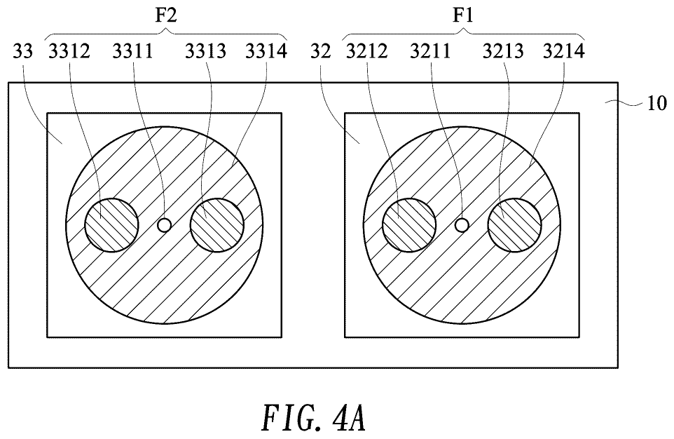

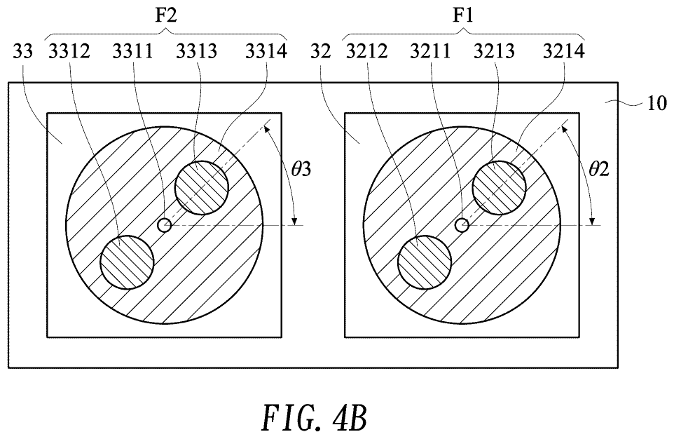

Please refer to FIG. 3A, FIG. 3B, FIG. 4A and FIG. 4B. FIG. 3A is a first schematic view of an input optical path of the depolarization integrated optical chip module in accordance with the first embodiment of the disclosure. FIG. 3B is a second schematic view of the input optical path of the depolarization integrated optical chip module in accordance with the first embodiment of the disclosure. FIG. 4A is a first schematic view of an output optical path of the depolarization integrated optical chip module in accordance with the first embodiment of the disclosure. FIG. 4B is a second schematic view of the output optical path of the depolarization integrated optical chip module in accordance with the first embodiment of the disclosure. The input optical path Fz includes a fiber core 3111, a first applying rod 3112, a second applying rod 3113, and a cladding layer 3114. The first output optical path F1 includes a fiber core 3211, a first applying rod 3212, a second applying rod 3213, and a cladding layer 3214. The second output optical path F2 includes a fiber core 3311, a first applying rod 3312, a second applying rod 3313, and a cladding layer 3314. The fiber cores 3111, 3211, 3311, the first applying rods 3112, 3212, 3312, and the second applying rods 3113, 3213, 3313 are respectively covered by the cladding layers 3114, 3214, 3314. The first applying rods 3112, 3212, 3312 and the second applying rods 3113, 3213, 3313 are respectively disposed around the outer peripheries of the fiber cores 3111, 3211, 3311 and arranged annularly at equal intervals. In one example, the cladding layers 3114, 3214, 3314 may be made of resin.

As shown in FIG. 3A, the straight line passing through the central points of the first applying rod 3112 and the second applying rod 3113 of the input optical path Fz is parallel to a horizontal plane. This horizontal plane serves as a reference plane. The horizontal plane is parallel to the straight line passing through the central points of the fiber core 3211 of the first output optical path F1 and the fiber core 3311 of the second output optical path F2, or is parallel to the upper surface of the chip body 10.

As shown in FIG. 3B, the straight line passing through the central points of the first applying rod 3112 and the second applying rod 3113 of the input optical path Fz is inclined relative to the above horizontal plane by an angle θ1 with the fiber core 3111 serving as the center. The angle θ1 is 45°. The input optical path Fz shown in FIG. 3A can be rotated counterclockwise by 45° to achieve the state of the input optical path Fz shown in FIG. 3B.

As shown in FIG. 4A, the straight line passing through the central points of the first applying rod 3212 and the second applying rod 3213 of the first output optical path F1 is parallel to the above horizontal plane. The straight line passing through the central points of the first applying rod 3312 and the second applying rod 3313 of the second output optical path F2 is also parallel to the above horizontal plane.

As shown in FIG. 4B, the straight line passing through the central points of the first applying rod 3212 and the second applying rod 3213 of the first output optical path F1 is inclined relative to the horizontal plane by an angle θ2 with the fiber core 3211 serving as the center. The angle θ2 is 45°. The first output optical path F1 shown in FIG. 4A can be rotated counterclockwise by 45° to achieve the state of the first output optical path F1 shown in FIG. 4B. The straight line passing through the central points of the first applying rod 3312 and the second applying rod 3313 of the second output optical path F2 is inclined relative to the horizontal plane by an angle θ3 with the fiber core 3311 serving as the center. The angle θ3 is 45°. The second output optical path F2 shown in FIG. 4A can be rotated counterclockwise by 45° to achieve the state of the second output optical path F2 shown in FIG. 4B.

In one embodiment, the input optical path Fz is as shown in FIG. 3A, and the first output optical path F1 and the second output optical path F2 are as shown in FIG. 4B.

In another embodiment, the input optical path Fz is as shown in FIG. 3B, and the first output optical path F1 and the second output optical path F2 are as shown in FIG. 4A.

In yet another embodiment, the input optical path Fz is as shown in FIG. 3B, and the first output optical path F1 and the second output optical path F2 are as shown in FIG. 4B.

By designing the first stress applying rod 3112 and the second stress applying rod 3113 of the input optical path Fz, the first stress applying rod 3212 and the second stress applying rod 3213 of the first output optical path F1, and the first stress applying rod 3312 and the second stress applying rod 3313 of the second output optical path F2 to be rotated by 45° when packaging the depolarization integrated optical chip module 1, the fiber optic gyroscope 100 connected after the output ends (first output connection portion 32 and second output connection portion 33) can use single-mode fiber instead of polarization maintaining fiber, which helps to significantly reduce the manufacturing cost of the fiber optic gyroscope 100.

The embodiment just exemplifies the disclosure and is not intended to limit the scope of the disclosure. Any equivalent modification and variation according to the spirit of the disclosure is to be also included within the scope of the following claims and their equivalents.

In summary, by inclining the first applying rod and the second applying rod of the second waveguide optical path and the third waveguide optical path relative to the horizontal plane with the fiber core serving as the center, the production costs of the integrated optical chip module 1 can be reduced and the depolarization effect thereof can be also improved.

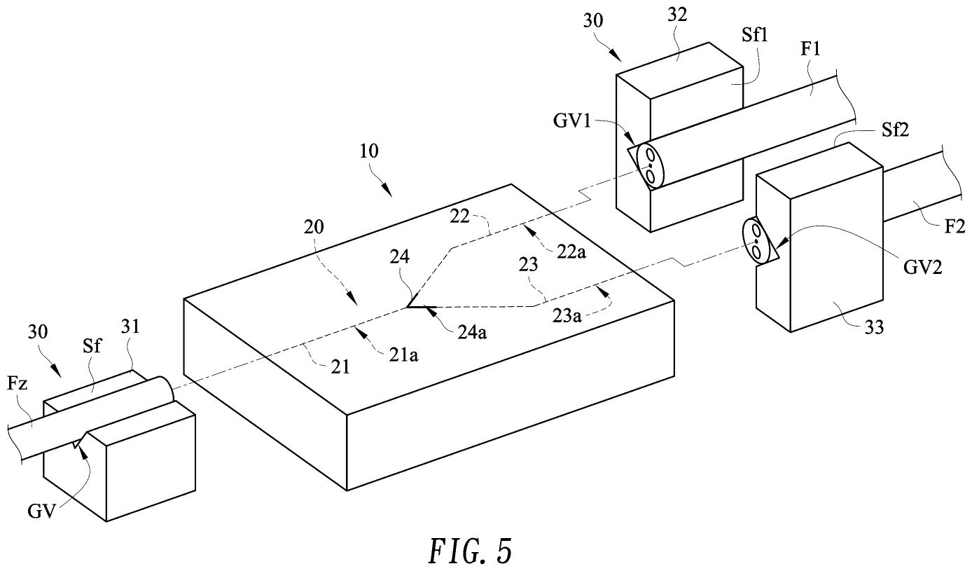

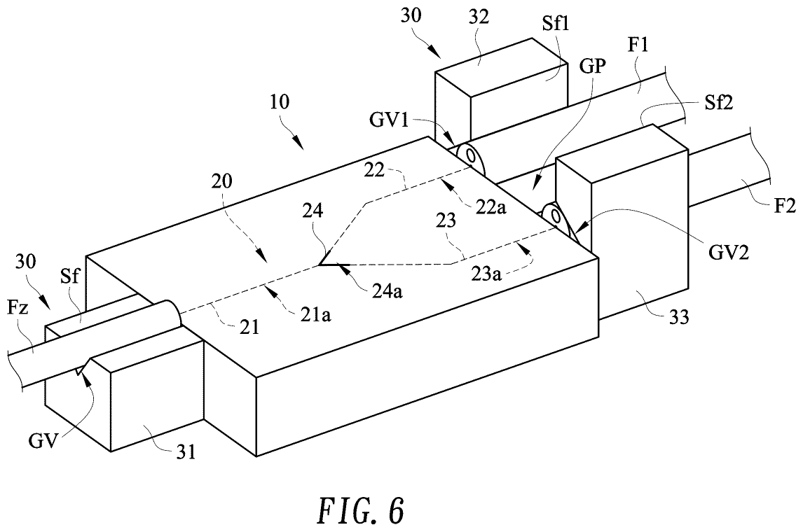

Please refer to FIG. 5 and FIG. 6. FIG. 5 is an exploded view of a depolarization integrated optical chip module in accordance with a second embodiment of the disclosure. FIG. 6 is a perspective view of the depolarization integrated optical chip module in accordance with the second embodiment of the disclosure. As shown in FIG. 5 and FIG. 6, the depolarization integrated optical chip module 1 includes a chip body 10, an optical fiber circuit 20, and a light guiding structure 30.

The chip body 10 has a first end 11 and a second end 12 opposite to the first end 11.

The light guiding structure 30 includes an input connection portion 31, a first output connection portion 32, and a second output connection portion 33. The input connection portion 31 is disposed at the first end 11. The first output connection portion 32 and the second output connection portion 33 are disposed at the second end 12. The input connection portion 31, the first output connection portion 32, and the second output connection portion 33 are all substrates, such as silicon substrates.

The optical fiber circuit 20 includes a first waveguide optical path 21, a second waveguide optical path 22, a third waveguide optical path 23, an input optical path Fz, a first output optical path F1, and a second output optical path F2. The first waveguide optical path 21, the second waveguide optical path 22, and the third waveguide optical path 23 are connected to each other and disposed in the chip body 10. The input optical path Fz is disposed on the input connection portion 31 and connected to the first waveguide optical path 21. The first output optical path F1 and the second output optical path F2 are respectively disposed on the first output connection portion 32 and the second output connection portion 33, and are respectively connected to the second waveguide optical path 22 and the third waveguide optical path 23.

The input connection portion 31 has an installation surface Sf. The installation surface Sf has a groove GV, and the input optical path Fz is disposed in the groove GV.

The first output connection portion 32 has a first installation surface Sf1. The first installation surface Sf1 has a first groove GV1, and the first output optical path F1 is disposed in the first groove GV1. The second output connection portion 33 has a second installation surface Sf2. The second installation surface Sf2 has a second groove GV2, and the second output optical path F2 is disposed in the second groove GV2. As previously stated, the first output connection portion 32 and the second output connection portion 33 are disposed at the second end 12, so that the first installation surface Sf1 of the first output connection portion 32 faces the second installation surface Sf2 of the second output connection portion 33. In this way, a gap GP can be formed between the first output connection portion 32 and the second output connection portion 33.

The operating mechanism of the integrated optical chip module 1 is the same as that of the aforementioned embodiments, and is therefore not redundantly described here.

The embodiment just exemplifies the disclosure and is not intended to limit the scope of the disclosure. Any equivalent modification and variation according to the spirit of the disclosure is to be also included within the scope of the following claims and their equivalents.

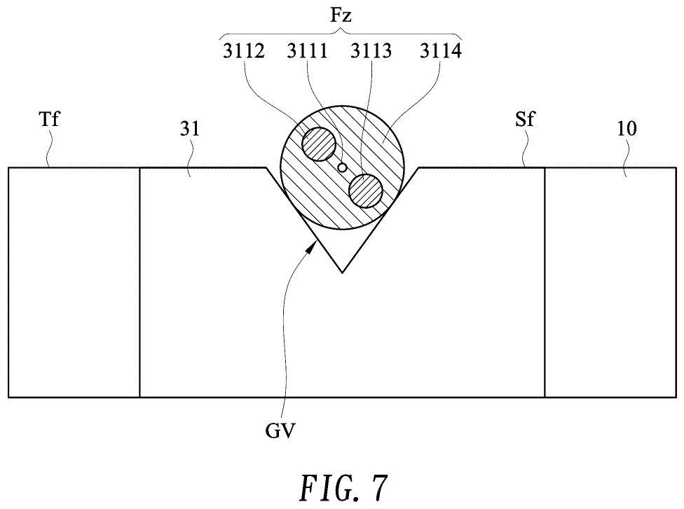

Please refer to FIG. 7, which is a schematic view of an input optical path of the depolarization integrated optical chip module in accordance with the second embodiment of the disclosure. As shown in FIG. 7, the input optical path Fz includes a fiber core 3111, a first applying rod 3112, a second applying rod 3113, and a cladding layer 3114. The fiber core 3111, the first applying rod 3112, and the second applying rod 3113 are covered by the cladding layer 3114. The first applying rod 3112 and the second applying rod 3113 are respectively disposed on the outer periphery of the fiber core 3111 and arranged annularly at equal intervals. Similarly, the straight line passing through the central points of the first applying rod 3112 and the second applying rod 3113 of the input optical path Fz is inclined relative to a horizontal plane by an angle θ1 with the fiber core 3111 serving as the center, as shown in FIG. 3B. In another embodiment, the straight line passing through the central points of the first applying rod 3112 and the second applying rod 3113 of the input optical path Fz may also be parallel to the horizontal plane. This horizontal plane serves as a reference plane. The horizontal plane is parallel to the straight line passing through the central points of the fiber core 3211 of the first output optical path F1 and the fiber core 3311 of the second output optical path F2, or is parallel to the upper surface Tf of the chip body 10.

The embodiment just exemplifies the disclosure and is not intended to limit the scope of the disclosure. Any equivalent modification and variation according to the spirit of the disclosure is to be also included within the scope of the following claims and their equivalents.

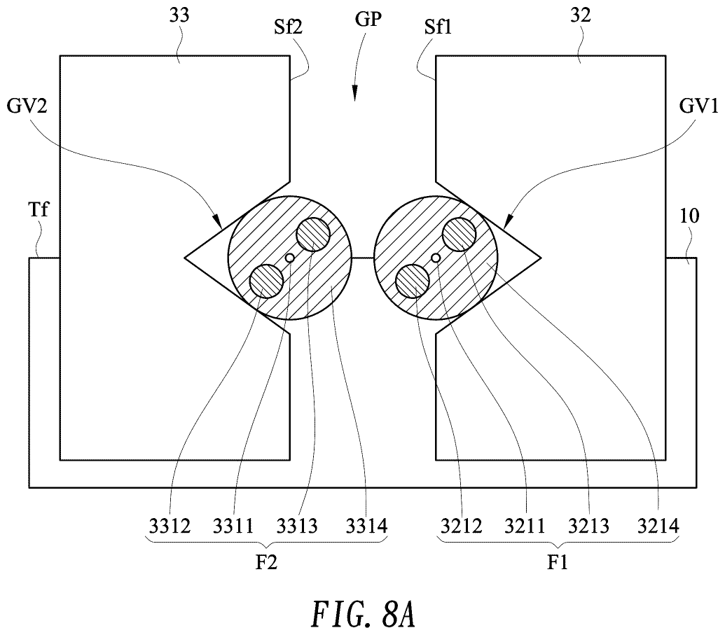

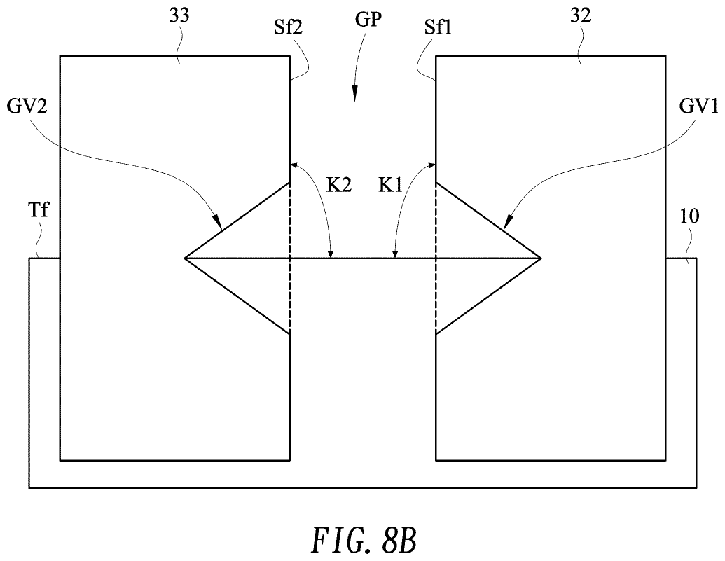

Please refer to FIG. 8A, which is a first schematic view of an output optical path of the depolarization integrated optical chip module in accordance with the second embodiment of the disclosure. As shown in FIG. 8A, the first output optical path F1 includes a fiber core 3211, a first applying rod 3212, a second applying rod 3213, and a cladding layer 3214. The fiber core 3211, the first applying rod 3212, and the second applying rod 3213 are covered by the cladding layer 3214. The first applying rod 3212 and the second applying rod 3213 are respectively disposed on the outer periphery of the fiber core 3211 and arranged annularly at equal intervals. Similarly, the straight line passing through the central points of the first applying rod 3212 and the second applying rod 3213 of the first output optical path F1 is inclined relative to the horizontal plane by an angle θ2 with the fiber core 3211 serving as the center, as shown in FIG. 4B. In another embodiment, the straight line passing through the central points of the first applying rod 3212 and the second applying rod 3213 of the first output optical path F1 may also be parallel to the horizontal plane.

The second output optical path F2 includes a fiber core 3311, a first applying rod 3312, a second applying rod 3313, and a cladding layer 3314. The fiber core 3311, the first applying rod 3312, and the second applying rod 3313 are covered by the cladding layer 3314. The first applying rod 3312 and the second applying rod 3313 are respectively disposed on the outer periphery of the fiber core 3311 and arranged annularly at equal intervals. Similarly, the straight line passing through the central points of the first applying rod 3312 and the second applying rod 3313 of the second output optical path F2 is inclined relative to the horizontal plane by an angle θ3 with the fiber core 3311 serving as the center, as shown in FIG. 4B. In another embodiment, the straight line passing through the central points of the first applying rod 3312 and the second applying rod 3313 of the second output optical path F2 may also be parallel to the horizontal plane.

As shown in FIG. 8A, the first installation surface Sf1 of the first output connection portion 32 faces the second installation surface Sf2 of the second output connection portion 33, such that the first groove GV1 also faces the second groove GV2. A gap GP is formed between the first output connection portion 32 and the second output connection portion 33.

The embodiment just exemplifies the disclosure and is not intended to limit the scope of the disclosure. Any equivalent modification and variation according to the spirit of the disclosure is to be also included within the scope of the following claims and their equivalents.

Please refer to FIG. 8B, which is a second schematic view of the output optical path of the depolarization integrated optical chip module in accordance with the second embodiment of the disclosure (with the first output optical path F1 and the second output optical path F2 removed). As shown FIG. 8B, a first included angle K1 is formed between the first installation surface Sf1 and the upper surface Tf of the chip body 10, and the first included angle K1 is between 80° and 100°. A second included angle K2 is formed between the second installation surface Sf2 and the upper surface Tf of the chip body 10, and the second included angle K2 is between 80° and 100°. In this embodiment, the first included angle K1 may be 90°, slightly greater than 90°, or slightly less than 90°. The second included angle K2 may be 90°, slightly greater than 90°, or slightly less than 90°.

The embodiment just exemplifies the disclosure and is not intended to limit the scope of the disclosure. Any equivalent modification and variation according to the spirit of the disclosure is to be also included within the scope of the following claims and their equivalents.

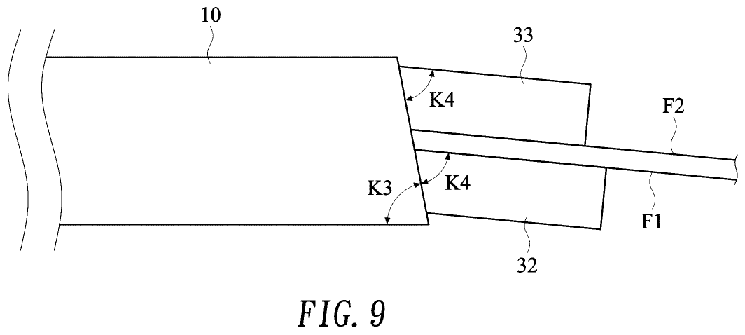

Please refer to FIG. 9, which is a top view of the depolarization integrated optical chip module in accordance with the second embodiment of the disclosure. As shown in FIG. 9, during the manufacturing process, a polish process may be performed on one end of the chip body 10. A third included angle K3 is formed between the slanted edge, contacting the first output connection portion 32 and the second output connection portion 33, of the top surface of the chip body 10 and the bottom edge of the top surface of the chip body 10 (the bottom edge refers to the edge with a smaller included angle with the aforementioned slanted edge). The third included angle may be between 70° and 90°. In this embodiment, the third included angle K3 is 80°, that is, one end of the chip body 10 is ground at an angle of 10°.

During the manufacturing process, a polish process may be performed on one end of the first output connection portion 32, so that a fourth included angle K4 is formed between the slanted edge, contacting the chip body 10, of the top surface of the first output connection portion 32 and the top edge of the top surface of the first output connection portion 32 (the top edge refers to the edge with a smaller included angle with the aforementioned slanted edge). The fourth included angle K4 may be between 70° and 90°, and the fourth included angle K4 is not equal to the third included angle K3. In this embodiment, the fourth included angle K4 is 75°.

Similarly, a polish process may be performed on one end of the second output connection portion 33, so that the fourth included angle K4 is formed between the slanted edge, contacting the chip body 10, of the top surface of the second output connection portion 33 and the top edge of the top surface of the second output connection portion 33.

The structure formed by the above grinding process can effectively improve the anti-reflection effect, which can further enhance the depolarization effect.

The embodiment just exemplifies the disclosure and is not intended to limit the scope of the disclosure. Any equivalent modification and variation according to the spirit of the disclosure is to be also included within the scope of the following claims and their equivalents.

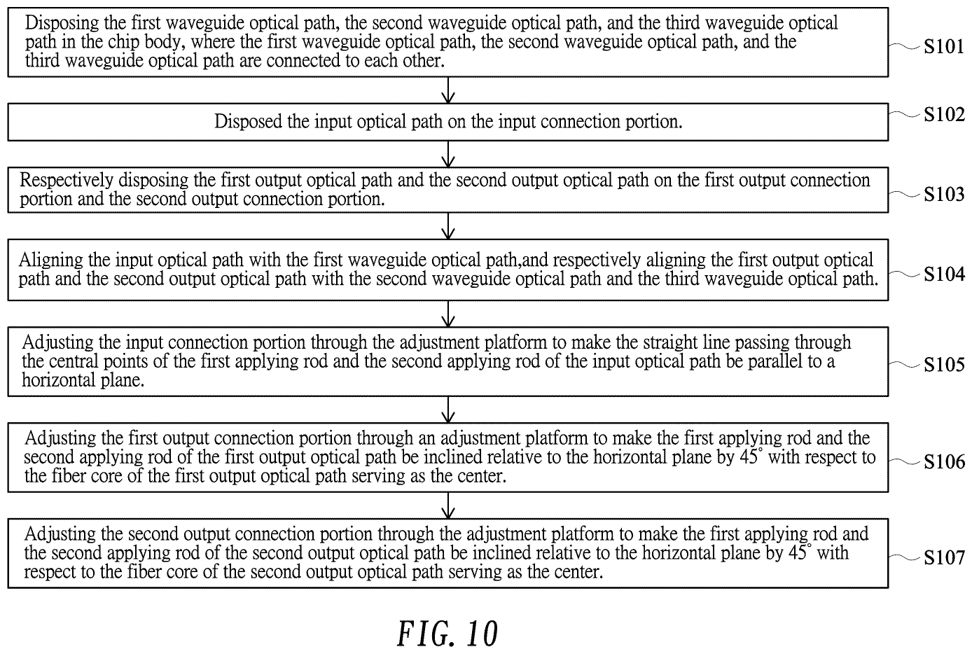

Please refer to FIG. 10, which is a flow chart of a method of manufacturing a depolarization integrated optical chip module in accordance with a third embodiment of the disclosure. First, the manufacturing engineer may perform a polish process on one end of the chip body 10 and one end of the first output connection portion 32.

Next, the manufacturing engineer performs a cutting process to form a groove GV on the installation surface Sf of the input connection portion 31 and places the input optical path Fz into the groove GV, such that the input optical path Fz can be disposed on the input connection portion 31. Similarly, the manufacturing engineer performs a cutting process to form a first groove GV1 on the first installation surface Sf1 of the first output connection portion 32 and places the first output optical path F1 into the first groove GV1, such that the first output optical path F1 can be disposed on the first output connection portion 32. The manufacturing engineer also performs a cutting process to form a second groove GV2 on the second installation surface Sf2 of the second output connection portion 33 and places the second output optical path F2 into the second groove GV2, such that the second output optical path F2 can be disposed on the second output connection portion 33.

Then, the manufacturing engineer form the first waveguide optical path 21, second waveguide optical path 22, and third waveguide optical path 23 in the chip body 10. The first waveguide optical path 21, second waveguide optical path 22, and third waveguide optical path 23 are connected to each other.

Next, the manufacturing engineer aligns the input optical path Fz with the first waveguide optical path 21, and aligns the first output optical path F1 and the second output optical path F2 with the second waveguide optical path 22 and the third waveguide optical path 23, respectively. The manufacturing engineer then connects the input optical path Fz to a broadband light source and connects the first output optical path F1 and the second output optical path F2 to a polarization extinction ratio meter.

Then, the manufacturing engineer adjusts the first output connection portion 32 using an adjustment platform (such as a six-axis manual stage alignment unit). The manufacturing engineer stops the adjustment once the ER value measured by the polarization extinction ratio meter approaches 0 dB. At this time, the first applying rod 3212 and the second applying rod 3213 of the first output optical path F1 are inclined relative to the horizontal plane by 45° with the fiber core 3211 of the first output optical path F1 serving as the center. Similarly, the manufacturing engineer adjusts the second output connection portion 33 using the adjustment platform. The manufacturing engineer stops the adjustment once the ER value measured by the polarization extinction ratio meter approaches 0 dB. At this time, the first applying rod 3312 and the second applying rod 3313 of the second output optical path F2 are inclined relative to the horizontal plane by 45° with the fiber core 3311 of the second output optical path F2 serving as the center. The manufacturing engineer may then fix the first output connection portion 32 and the second output connection portion 33 to the chip body 10 via the adhesive (such as UV glue). In this state, there is a gap GP formed between the first output connection portion 32 and the second output connection portion 33. Besides, the first installation surface Sf1 of the first output optical path F1 faces the second installation surface Sf2 of the second output optical path F2.

Next, the manufacturing engineer connects the first output optical path F1 and the second output optical path F2 to the broadband light source and connects the input optical path Fz to the polarization extinction ratio meter. The manufacturing engineer adjusts the input connection portion 31 using the adjustment platform. The manufacturing engineer stops the adjustment once the ER value measured by the polarization extinction ratio meter approaches 0 dB. At this time, the first applying rod 3112 and the second applying rod 3113 of the input optical path Fz are inclined relative to the horizontal plane by 45° with the fiber core 3111 of the input optical path Fz serving as the center. The manufacturing engineer may then fix the input connection portion 31 to the chip body 10 via the adhesive.

As set forth above, the first output optical path F1 and the second output optical path F2 are respectively disposed on the first output connection portion 32 and the second output connection portion 33. Accordingly, there is a gap GP formed between the first output connection portion 32 and the second output connection portion 33. Thus, the manufacturing engineer can independently adjust the angles of the first output connection portion 32 and the second output connection portion 33 to achieve the optimal rotation angles of the first output optical path F1 and the second output optical path F2. Therefore, the depolarization effect of the depolarization integrated optical chip module 1 can be optimized in order to meet actual requirements.

As shown in FIG. 10, the method of this embodiment includes the following steps:
Step S101: disposing the first waveguide optical path, the second waveguide optical path, and the third waveguide optical path in the chip body, where the first waveguide optical path, the second waveguide optical path, and the third waveguide optical path are connected to each other.
Step S102: disposed the input optical path on the input connection portion.
Step S103: respectively disposing the first output optical path and the second output optical path on the first output connection portion and the second output connection portion.
Step S104: aligning the input optical path with the first waveguide optical path, and respectively aligning the first output optical path and the second output optical path with the second waveguide optical path and the third waveguide optical path.
Step S105: adjusting the input connection portion through the adjustment platform to make the straight line passing through the central points of the first applying rod and the second applying rod of the input optical path be parallel to a horizontal plane.
Step S106: adjusting the first output connection portion through an adjustment platform to make the first applying rod and the second applying rod of the first output optical path be inclined relative to the horizontal plane by 45° with respect to the fiber core of the first output optical path serving as the center.
Step S107: adjusting the second output connection portion through the adjustment platform to make the first applying rod and the second applying rod of the second output optical path be inclined relative to the horizontal plane by 45° with respect to the fiber core of the second output optical path serving as the center.

The embodiment just exemplifies the disclosure and is not intended to limit the scope of the disclosure. Any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A depolarization integrated optical chip module, comprising:
a chip body having a first end and a second end opposite to the first end;
a light guiding structure comprising an input connection portion disposed at the first end, a first output connection portion, and a second output connection portion disposed at the second end; and
an optical fiber circuit comprising a first waveguide optical path, a second waveguide optical path, a third waveguide optical path, an input optical path, a first output optical path, and a second output optical path, wherein the first waveguide optical path, the second waveguide optical path, and the third waveguide optical path are connected with each other and disposed in the chip body, wherein the input optical path, the first output optical path, and the second output optical path are respectively disposed on the input connection portion, the first output connection portion, and the second output connection portion, and are respectively connected to the first waveguide optical path, the second waveguide optical path, and the third waveguide optical path;
wherein each of the input optical path, the first output optical path, and the second output optical path comprises a fiber core, a first applying rod, and a second applying rod, and the first applying rod and the second applying rod are disposed on an outer periphery of the fiber core and arranged annularly at equal intervals, and the first applying rod and the second applying rod of each of the first output optical path and the second output optical path are inclined relative to a horizontal plane by 45 degrees with respect to the fiber core serving as a center.

2. The depolarization integrated optical chip module as claimed in claim 1, wherein the input optical path, the first output optical path, and the second output optical path are polarization-maintaining fibers.

3. The depolarization integrated optical chip module as claimed in claim 1, wherein the optical fiber circuit further comprises a light splitting unit connected to the first waveguide optical path, the second waveguide optical path, and the third waveguide optical path, and configured to separate an optical signal.

4. The depolarization integrated optical chip module as claimed in claim 1, wherein the input optical path disposed on the input connection portion is configured to receive an optical signal.

5. The depolarization integrated optical chip module as claimed in claim 1, wherein the first output optical path disposed on the first output connection portion is configured to output an optical signal.

6. The depolarization integrated optical chip module as claimed in claim 1, wherein the second output optical path disposed on the second output connection portion is configured to output an optical signal.

7. The depolarization integrated optical chip module as claimed in claim 1, wherein a gap is formed between the first output connection portion and the second output connection portion.

8. The depolarization integrated optical chip module as claimed in claim 1, wherein the first output connection portion comprises a first installation surface having a first groove, and the first output optical path is disposed in the first groove, wherein the second output connection portion comprises a second installation surface having a second groove, and the second output optical path is disposed in the second groove, and the first installation surface faces the second installation surface.

9. The depolarization integrated optical chip module as claimed in claim 8, wherein the first installation surface forms a first included angle with an upper surface of the chip body, and the second installation surface forms a second included angle with the upper surface of the chip body, wherein the first included angle and the second included angle are between 80 degrees and 100 degrees.

10. The depolarization integrated optical chip module as claimed in claim 1, wherein a slanted edge, contacting the first output connection portion and the second output connection portion, of a top surface of the chip body forms a third included angle with a bottom edge of the top surface of the chip body, and the third included angle is between 70 degrees and 90 degrees.

11. The depolarization integrated optical chip module as claimed in claim 10, wherein a slanted edge, contacting the chip body, of a top surface of the first output connection portion forms a fourth included angle with a top edge of the top surface of the first output connection portion, and the fourth included angle is between 70 degrees and 90 degrees, and is not equal to the third included angle.

12. The depolarization integrated optical chip module as claimed in claim 10, wherein a slanted edge, contacting the chip body, of a top surface of the second output connection portion forms a fourth included angle with a top edge of the top surface of the second output connection portion, and the fourth included angle is between 70 degrees and 90 degrees, and is not equal to the third included angle.

13. A method of manufacturing a depolarization integrated optical chip module, comprising:
disposing a first waveguide optical path, a second waveguide optical path, and a third waveguide optical path in a chip body, wherein the first waveguide optical path, the second waveguide optical path, and the third waveguide optical path are connected to each other;
disposing an input optical path on an input connection portion;
respectively disposing a first output optical path and a second output optical path on a first output connection portion and a second output connection portion;
aligning the input optical path with the first waveguide optical path, and respectively aligning the first output optical path and the second output optical path with the second waveguide optical path and the third waveguide optical path;
adjusting the first output connection portion through an adjustment platform to make a first applying rod and a second applying rod of the first output optical path be inclined relative to a horizontal plane by 45 degrees with respect to a fiber core of the first output optical path serving as a center; and
adjusting the second output connection portion through the adjustment platform to make a first applying rod and a second applying rod of the second output optical path be inclined relative to the horizontal plane by 45 degrees with respect to a fiber core of the second output optical path serving as the center.

14. The method of manufacturing the depolarization integrated optical chip module as claimed in claim 13, further comprising:
fixing the first output connection portion and the second output connection portion to the chip body.

15. The method of manufacturing the depolarization integrated optical chip module as claimed in 13, further comprising:
adjusting the input connection portion through the adjustment platform to make a straight line passing through central points of a first applying rod and a second applying rod of the input optical path be parallel to the horizontal plane.

16. The method of manufacturing the depolarization integrated optical chip module of claim 15, further comprising:
fixing the input connection portion to the chip body.

17. The method of manufacturing the depolarization integrated optical chip module of claim 13, further comprising:
forming a gap between the first output connection portion and the second output connection portion.

18. The method of manufacturing the depolarization integrated optical chip module of claim 13, further comprising:
forming a first groove on an installation surface of the first output connection portion;
disposing the first output optical path in the first groove;
forming a second groove on an installation surface of the second output connection portion; and
disposing the second output optical path in the second groove.

19. The method of manufacturing the depolarization integrated optical chip module of claim 18, further comprising:
orienting the installation surface of the first output optical path toward the installation surface of the second output optical path.
